(19) United States
(12) Patent Application Publication
(10) Pub. No.: US 2026/0301155 A1
(43) Pub. Date: Oct. 1, 2026

(54) Context Based Processes Augmented by Context Addressable Storage

(71) Applicant: KLA Corporation, Milpitas, CA (US)

(72) Inventors: Kris BHASKAR, San Jose, CA (US); Vijayakumar RAMACHANDRAN, Sunnyvale, CA (US); Arvind JAYARAMAN, Windsor (CA); Mark ROULO, Mountain View, CA (US); Brian Duffy, San Jose, CA (US)

(21) Appl. No.: 19/571,472

(22) Filed: Mar. 18, 2026

Related U.S. Application Data
(60) Provisional application No. 63/779,332, filed on Mar. 28, 2025.

(51) Int. Cl. G06T 7/00; G06T 1/60

(52) U.S. Cl. CPC G06T 7/0008; G06T 1/60; G06T 2207/30148

(57) ABSTRACT

Methods and systems for generating information for a specimen are provided. One system includes an imaging subsystem configured for generating images of a specimen. The system also includes a context addressable storage subsystem and one or more computer subsystems configured for storing the images in the context addressable storage subsystem with context associated with the images. The context includes at least spatial information for the images relative to one or more coordinate systems. The computer subsystem(s) are also configured for retrieving one or more of the images based on the context associated with the images. In addition, the computer subsystem(s) are configured for determining information for the specimen based on the retrieved one or more of the images and the context associated with the retrieved one or more of the images.

### BACKGROUND OF THE INVENTION

### 1. Field of the Invention

The present invention generally relates to methods and systems for context based processes like inspection of semiconductor related specimens augmented by context addressable storage.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on wafers to promote higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Methods and systems configured for performing the yield related processes described above are often developed by first finding the best possible hardware configuration for generating images, data, measurements, signals, etc. for the specimens. Once the hardware configuration has been established, parameters of the hardware that are best for the processes are selected. Hardware parameter selection can greatly affect how responsive the images, data, measurements, signals, etc. are to the specimen and how well they can be used for determining information for the specimen.

Sometimes even the best possible hardware configuration and associated parameters are not capable of generating output that is ideal for determining information for a specimen. For example, the best possible hardware configuration and parameters may still produce images that contain a significant amount of noise that can interfere with defect detection, metrology, and defect review. In such cases, the methods and systems may be configured to try to improve the images prior to using them to determine information for the specimen. Many different kinds of post-processing may be performed on the images, data, measurements, signals, etc. generated for a specimen by tool hardware.

Many approaches have been developed to not only determine which hardware and processing parameters are appropriate for a given specimen, but also which hardware and processing parameters are appropriate for different areas on the same specimen in the same inspection. For example, variation across the specimens described herein may mean that hardware and/or processing parameters that are most suitable in one specimen area are less than optimal or even completely useless in another specimen area.

Methods for selecting hardware and/or processing parameters that vary from specimen area to specimen area have been developed based on a number of characteristics of the specimens and the tools. Some specimen characteristics that have been considered primarily relate to a design formed on the specimen, including characteristics of patterned features in the design and where they are formed on the specimen. The characteristics of the design that may be used include characteristics that are independent of the tool and process like which of the patterned features in the design are most critical to the device function and therefore should be examined with the greatest sensitivity. The characteristics of the design may also or alternatively include characteristics of the design like dimensions, orientation, roughness, material properties, patterned features on underlying layers, etc., which can have some effect on the tool output and so can affect both the signal and the noise in the tool output.

Some other specimen characteristics that have been considered relate to noise in the tool output for different areas on the specimen. That noise may be related to the design being formed on the specimen as described above. The noise may also be related to other properties of the specimen like variations in the specimen caused by a process performed on the specimen. One obvious reason why hardware and/or processing parameters may be based on noise is that the noise can mask defect signals. For example, if the noise is too similar to the defect signals or even exceeds the defect signals, the defect signals may be missed and inspection may fail.

While it may seem relatively straightforward, these and other specimen characteristics as well as the tool configuration and its specimen-dependent performance make using the tool output in the best possible way often extremely difficult or even impractical to the point of impossibility. For example, the tools described above (and especially inspection tools) generate a significant amount of output (e.g., images) in a specific manner on the specimen (e.g., in image swaths). Due to the size of the images and the speed with which these images are generated, they are currently stored in the same manner in which they are generated. In other words, in a storage medium, the images may be stored based only on the swaths in which they were generated and their within swath locations.

While this manner of tool output storage may have been perfectly useful in the past, storing the tool output in this manner makes it significantly difficult to retrieve and process tool output based on other characteristics of the output. In just one non-limiting instance, to retrieve image data for corresponding design locations on the specimen, entire, multiple swaths may have to be retrieved (e.g., “played back”) in order to find the image portions that were generated at the same design locations in multiple dies on the specimen so that they can be processed together for applications like repeater detection, systematic defect detection, etc. Retrieving and collectively processing images having similar noise or other characteristics have the same difficulties.

Accordingly, it would be advantageous to develop systems and methods for generating information for a specimen that do not have one or more of the disadvantages described above.

### SUMMARY OF THE INVENTION

The following description of various embodiments is not to be construed in any way as limiting the subject matter of the appended claims.

One embodiment relates to a system configured for generating information for a specimen. The system includes an imaging subsystem configured for generating images of a specimen. The system also includes a context addressable storage subsystem and one or more computer subsystems. The one or more computer subsystems are configured for storing the images in the context addressable storage subsystem with context associated with the images. The context includes at least spatial information for the images relative to one or more coordinate systems. The computer subsystem(s) are also configured for retrieving one or more of the images based on the context associated with the images. In addition, the computer subsystem is configured for determining information for the specimen based on the retrieved one or more of the images and the context associated with the retrieved one or more of the images. The system may be further configured as described herein.

Another embodiment relates to a computer-implemented method for generating information for a specimen. The method includes generating images of a specimen with an imaging subsystem and storing the images in a context addressable storage subsystem with context associated with the images. The context includes at least spatial information for the images relative to one or more coordinate systems. The method also includes retrieving one or more of the images based on the context associated with the images and determining information for the specimen based on the retrieved one or more of the images and the context associated with the retrieved one or more of the images.

The steps of the method are performed by one or more computer subsystems. The steps of the method may be further performed as described herein. The method may include any other step(s) of any other method(s) described herein. The method may be performed by any of the systems described herein.

Another embodiment relates to a non-transitory computer-readable medium storing program instructions executable on one or more computer subsystems for performing a computer-implemented method for generating information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a flow chart illustrating an embodiment of steps that may be performed for determining information for a specimen;

FIG. 4 is a block diagram illustrating an embodiment of a system configured for determining information for a specimen;

FIG. 5 is a schematic diagram illustrating a plan view of an embodiment of areas on a specimen for which image frames may be generated and associated with context according to the embodiments described herein; and

FIG. 6 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

One embodiment relates to a system configured for generating information for a specimen. In general, the embodiments described herein are configured as context based inspection (or other) systems and methods augmented by context addressable storage. The embodiments are particularly useful for anomaly detection in the semiconductor and electronics industry, including reticles, wafers, packages, and subsystems, that may reasonably be expected to be subjected to image based inspection for the purpose of anomaly detection.

The terms “design,” “design data,” and “design information” as used interchangeably herein generally refer to the physical design (layout) of an IC or other semiconductor device and data derived from the physical design through complex simulation or simple geometric and Boolean operations. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data. Furthermore, the “design,” “design data,” and “design information” described herein refers to information and data that is generated by semiconductor device designers in a design process and is therefore available for use in the embodiments described herein well in advance of printing of the design on any physical specimens such as reticles and wafers.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

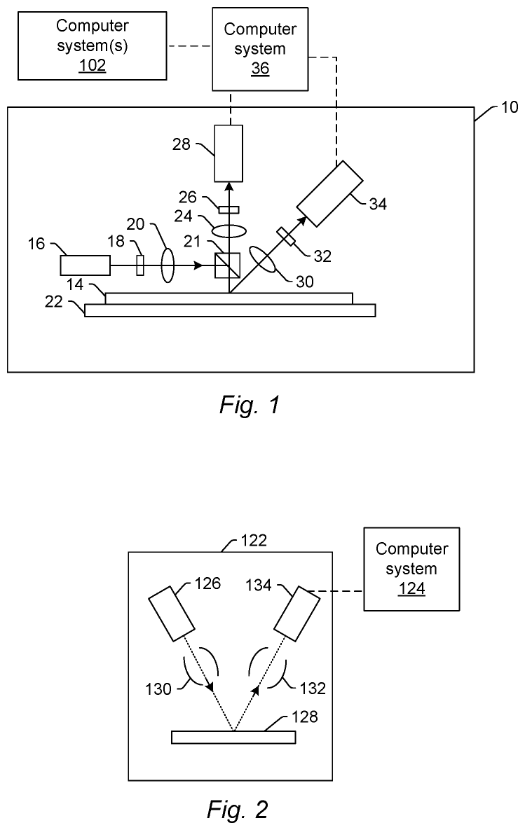

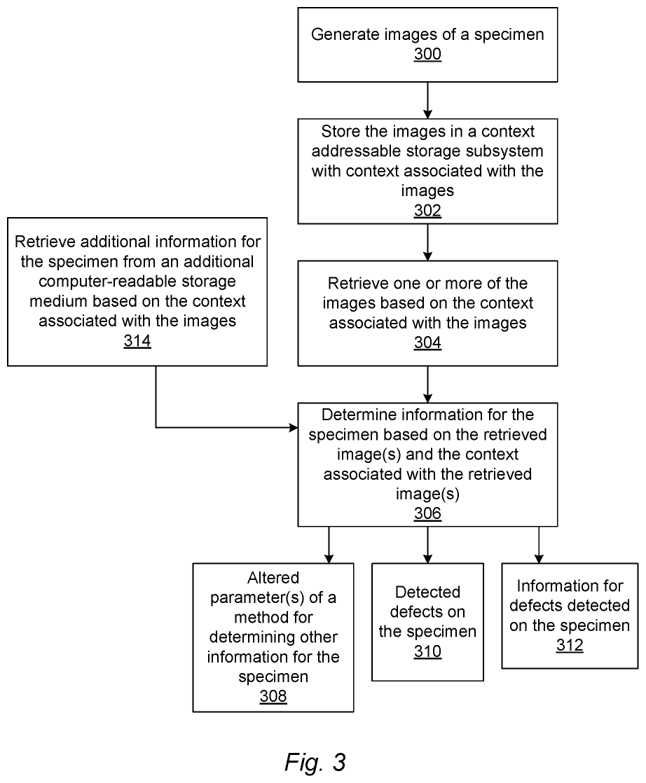

One embodiment of a system configured for generating information for a specimen is shown in FIG. 1. The system includes an imaging subsystem 10 configured for generating images of a specimen, as shown in step 300 of FIG. 3. The terms “imaging system” and “imaging subsystem” are used interchangeably herein. In one embodiment, the imaging subsystem is configured for generating images of the specimen by directing energy to a physical version of the specimen and detecting energy from the physical version of the specimen. In some embodiments, the imaging subsystem includes at least an energy source and a detector. The energy source is configured to generate energy that is directed to a specimen. The detector is configured to detect energy from the specimen and to generate output responsive to the detected energy.

In one embodiment, the energy source is a light source. For example, in a light-based imaging subsystem, the energy directed to the specimen includes light, and the energy detected from the specimen includes light. As shown in FIG. 1, imaging subsystem 10 includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to beam splitter 21, which directs the light to specimen 14 at a normal angle of incidence. The angle of incidence may, however, be any suitable angle of incidence, which may vary depending on, for instance, characteristics of the specimen and the defects to be detected on the specimen, the characteristics of the specimen to be measured, etc.

The illumination subsystem may be configured to direct the light to the specimen at different angles of incidence. For example, the imaging subsystem may be configured to alter one or more parameters of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at an oblique angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for imaging.

The imaging subsystem may also include a scanning subsystem configured to change the position on the specimen to which the light is directed and from which the light is detected and possibly to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging subsystem may be configured such that one or more optical elements of the imaging subsystem perform some scanning of the light over the specimen such that the light can be directed to and detected from different positions on the specimen. The light may be scanned over the specimen in any suitable fashion such as in a serpentine-like path or in a spiral path.

The imaging subsystem includes one or more detection channels. At least one of the detection channel(s) includes a detector configured to detect light from the specimen due to illumination of the specimen by the system and to generate output responsive to the detected light. The imaging subsystem shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging subsystem that includes two detection channels, the imaging subsystem may include a different number of detection channels (e.g., only one detection channel or two or more detection channels). The detection channel formed by collector 30, element 32, and detector 34 may form one side channel as described above, and the imaging subsystem may include an additional detection channel (not shown) formed as another side channel that is positioned on the opposite side of the plane of incidence. Therefore, the imaging subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging subsystem may also include two or more side channels configured as described above. As such, the imaging subsystem may include at least three channels (i.e., one top channel and two side channels), and each of the at least three channels is configured to collect light at different scattering angles than each of the other collectors.

As described further above, one or more of the detection channels may be configured to detect scattered light. Therefore, the imaging subsystem shown in FIG. 1 may be configured for dark field (DF) imaging. However, the imaging subsystem may also or alternatively include detection channel(s) that are configured for bright field (BF) imaging. Therefore, the imaging subsystems described herein may be configured for only DF, only BF, or both DF and BF imaging. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the light such as intensity but may not be configured to detect such characteristics as a function of position within the imaging plane. As such, the output that is generated by each of the detectors in each of the detection channels may be signals or data, but not image signals or image data. In such instances, a computer system may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

Computer system 36 may be coupled to the detectors of the imaging subsystem in any suitable manner (e.g., via one or more transmission media, which may include “wired” and/or “wireless” transmission media) such that the computer system can receive the output generated by the detectors. Computer system 36 may be configured to perform a number of functions using the output of the detectors as described further herein. Computer system 36 may be further configured as described herein.

Computer system 36 (as well as other computer systems described herein) may also be referred to herein as computer subsystem(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer system, then the different computer systems may be coupled to each other such that images, data, information, instructions, etc. can be sent between the computer systems. For example, computer system 36 may be coupled to computer system(s) 102 as shown by the dashed line in FIG. 1 by any suitable transmission media, which may include any suitable wired and/or wireless transmission media known in the art. Two or more of such computer systems may also be effectively coupled by a shared computer-readable storage medium (not shown).

In another embodiment, the energy source is an electron beam source. For example, in an electron beam imaging subsystem, the energy directed to the specimen includes electrons, and the energy detected from the specimen includes electrons. In one such embodiment shown in FIG. 2, the imaging subsystem includes electron column 122, and the system includes computer system 124 coupled to the imaging subsystem. Computer system 124 may be configured as described above. In addition, such an imaging subsystem may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Mar. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam imaging subsystem may be configured to use multiple modes to generate output for the specimen as described further herein (e.g., with different illumination angles, collection angles, etc.). The multiple modes of the electron beam imaging subsystem may be different in any output generation parameters of the imaging subsystem.

Computer system 124 may be coupled to detector 134 as described above. The detector may detect electrons returned from the surface of the specimen thereby forming electron beam images of (or other output for) the specimen. The electron beam images may include any suitable electron beam images. Computer system 124 may be configured to perform any step(s) described herein. A system that includes the imaging subsystem shown in FIG. 2 may be further configured as described herein.

FIGS. 1 and 2 are provided herein to generally illustrate configurations of an imaging subsystem that may be included in the system embodiments described herein. Obviously, the imaging subsystem configurations described herein may be altered to optimize the performance of the imaging subsystem as is normally performed when designing a commercial imaging system. In addition, the systems described herein may be implemented using an existing imaging subsystem (e.g., by adding functionality described herein to an existing inspection system) such as those included in tools that are commercially available from KLA Corp., Milpitas, Calif. Examples of such tools include, but are not limited to, the eSL10, eSi50, and eSV100 ebeam inspection systems, eDRX1 and eDRX2 defect review systems, and the eM1 metrology system. For some such systems, the methods described herein may be provided as optional functionality of the imaging subsystem (e.g., in addition to other functionality of the imaging system). Alternatively, the imaging system described herein may be designed “from scratch” to provide a completely new system.

Although the imaging subsystem is described above as being a light or electron beam imaging subsystem, the imaging subsystem may be an ion beam imaging subsystem. Such an imaging subsystem may be configured as shown in FIG. 2 except that the electron beam source may be replaced with any suitable ion beam source known in the art. In addition, the imaging subsystem may include any other suitable ion beam system such as those included in commercially available focused ion beam (FIB) systems, helium ion microscopy (HIM) systems, and secondary ion mass spectroscopy (SIMS) systems.

The imaging subsystem may be configured to generate output, e.g., images, of the specimen with multiple modes. In general, a “mode” is defined by the values of parameters of the imaging subsystem used for generating images of a specimen (or the output used to generate images of the specimen). Therefore, modes may be different in the values for at least one of the parameters of the imaging subsystem (other than lateral position on the specimen at which the output is generated). For example, the modes may be different in any one or more alterable parameters (e.g., illumination polarization(s), angle(s), wavelength(s), etc., detection polarization(s), angle(s), wavelength(s), etc.) of the imaging subsystem. The imaging subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

In some embodiments, the imaging subsystems described herein may be configured as an inspection subsystem, a metrology subsystem, and/or a defect review subsystem. For example, the embodiments of the imaging subsystem shown in FIGS. 1 and 2 may be modified in one or more parameters to provide different imaging capability depending on the application for which it will be used. In one such example, the imaging subsystem may be configured to have a higher resolution if it is to be used for metrology rather than for inspection. In other words, the embodiments of the imaging subsystem shown in FIGS. 1 and 2 describe some general and various configurations for an imaging subsystem that can be tailored in a number of manners that will be obvious to one skilled in the art to produce systems having different imaging capabilities that are more or less suitable for different applications.

In this manner, the imaging subsystem may be configured for generating output that is suitable for detecting or re-detecting defects on the specimen in the case of an inspection system or a defect review system, respectively, and for measuring one or more characteristics of the specimen in the case of a metrology system. In an inspection system, computer system 36 shown in FIG. 1 may be configured for detecting defects on specimen 14 by applying a defect detection method or algorithm to output generated by one or more of the detectors. In a defect review system, computer system 124 shown in FIG. 2 may be configured for re-detecting defects on specimen 128 by applying a defect re-detection method to the output generated by detector 134 and possibly determining additional information for the re-detected defects using the output generated by the detector. In a metrology system, computer system 36 shown in FIG. 1 may be configured for determining one or more characteristics of specimen 14 using the output generated by detectors 28 and/or 34. The system may be further configured for detecting or re-detecting defects on the specimen, determining characteristics of the specimen, determining other information for the specimen, etc. in any suitable manner known in the art.

As noted above, the imaging system may be configured for directing energy (e.g., light, electrons) to and/or scanning energy over a physical version of the specimen thereby generating actual images for the physical version of the specimen. In this manner, the imaging system may be configured as an “actual” imaging system, rather than a “virtual” system. However, in another embodiment, the imaging subsystem is configured as a virtual imaging subsystem configured for generating the images from a computer-readable storage medium in which the images have been stored by an additional imaging subsystem configured for generating the images by directing energy to a physical version of the specimen and detecting energy from the physical version of the specimen. For example, a storage medium (not shown) and computer system(s) 102 shown in FIG. 1 may be configured as a “virtual” system. In particular, the storage medium and the computer system(s) are not part of imaging system 10 and do not have any capability for handling the physical version of the specimen but may be configured as a virtual inspector that performs inspection-like functions, a virtual metrology system that performs metrology-like functions, a virtual defect review tool that performs defect review-like functions, etc. using stored detector output. Systems and methods configured as “virtual” systems are described in commonly assigned U.S. Pat. No. 8,126,255 issued on Feb. 28, 2012 to Bhaskar et al., U.S. Pat. No. 9,222,895 issued on Dec. 29, 2015 to Duffy et al., and U.S. Pat. No. 9,816,939 issued on Nov. 14, 2017 to Duffy et al., which are incorporated by reference as if fully set forth herein. The embodiments described herein may be further configured as described in these patents. For example, a computer system described herein may be further configured as described in these patents.

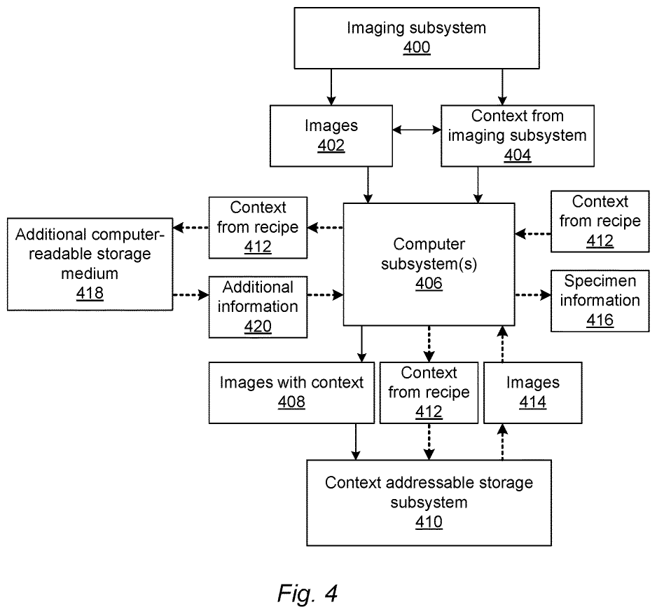

The system includes a context addressable storage subsystem (e.g., context addressable storage subsystem 410 shown in FIG. 4). A “context addressable storage subsystem” as that term is used herein is generally defined as any computer-readable storage medium/media and any associated hardware/software that stores information in such a way that is can be retrieved based not on storage location (or not only based on storage location) but based on the content of the data (as defined by the context described herein). For example, as new data (e.g., images described herein) is sent to a context addressable storage subsystem, any context associated with the data may be hashed, and the data may then be stored based on the associated hash(es) rather than in a commonly used directory. The data that is then stored in the context addressable storage subsystem can then be retrieved as described herein based on some input hashes rather than based on where or how the data is stored (e.g., its physical storage location, information for the file system in which the data is stored, etc.). The context addressable storage subsystem may be further configured as described in U.S. Patent Application Publication No. 2025/0053597 to Canessa et al. published Feb. 13, 2025, which is incorporated by reference as if fully set forth herein.

The system also includes one or more computer subsystems, which may include any of the computer subsystem(s) described further herein (e.g., computer subsystem(s) 406), configured for storing the images in the context addressable storage subsystem with context associated with the images, as shown in step 302 of FIG. 3. For example, as shown in FIG. 4, imaging subsystem 400 may generate images 402 with context 404 from the imaging subsystem. The imaging subsystem may send the images and this context to computer subsystem(s) 406. The computer subsystem(s) may then store images with context 408, i.e., images 402 with context 404, in context addressable storage subsystem 410. As described further herein, the imaging subsystem may be a virtual inspection system or a real inspection system. As such, the images can come from a simulation or archives or a physical tool with a physical wafer mounted therein (e.g., an electron beam inspector, an electron beam review/metrology tool, etc.).

The images from any of such systems in addition to any context generated by such systems, any context used with such images, and/or any context generated by the computer subsystem(s) may be stored in the context addressable storage subsystem by the computer subsystem(s). For example, the physical stage location at the time the image swath is acquired from the specimen is an integral part of the frame metadata generation process in that all frame coordinates are directly tied to the swath coordinates. However, the context may include context that is not generated by the imaging subsystem itself but is generated by another system or method and is associated with the images by the imaging subsystem or the computer subsystem(s). For example, the imaging subsystem may generate images of the specimen and spatial information for the images that includes only specimen coordinates of the images. If the computer subsystem(s) have other spatial information for the images that can be associated with the images based on the specimen coordinates (like design information or coordinates that can be associated with the images based on their specimen coordinates and some image align-to-design results, which may be generated by any align-to-design method or system known in the art such as those described in the patents to Kulkarni et al. and Zafar et al. incorporated by reference above as if fully set forth herein), the computer subsystem(s) may store the images with both the context generated by the imaging subsystem and the computer subsystem(s). The computer subsystem(s) may generate and store other context information (e.g., noise characteristics) associated with the images in the context addressable storage subsystem in the same manner.

The computer subsystem(s) may also perform any suitable post-processing on the images and their associated context prior to storing them in the context addressable storage subsystem. The post-processing may include any post-processing of images, data, image data, etc. performed in any of the processes described herein. The arrows between elements in FIG. 4 that have solid lines indicate the flow for storing images and context from the imaging subsystem. The arrows having dotted lines in FIG. 4 are meant to illustrate the flow for retrieval and post-retrieval processing.

In this manner, the context addressable storage subsystem is populated with context associated with images acquired from an image based inspector or other tool described herein. As described above, the image based inspector or other tool may be configured for generating images of a specimen by directing energy to and detecting energy from a physical version of the specimen. For example, an actual inspection system may serve as a source for the image frame data described herein that includes the frame level metadata sufficient to precisely associate it with the context data described further herein. Alternatively, the image based inspector or other tool may be configured as a virtual tool. In this manner, the context addressable storage subsystem may be coupled to an actual imaging subsystem or form a virtual integrated context addressable storage subsystem. In one such example, a virtual inspection system may serve as a source of the frame data described further herein, which may include the frame level metadata sufficient to precisely associate it with the context data described further herein. As such, imaging subsystem 400 shown in FIG. 4 may be an imaging subsystem that generates images of a specimen from the physical version of the specimen or a virtual imaging subsystem.

The context includes at least spatial information for the images relative to one or more coordinate systems. The one or more coordinate systems may vary depending on the subsystem that generates the images, the specimen itself, etc. Examples of such coordinate systems include, but are not limited to, specimen coordinates, design coordinates (i.e., coordinates of the images relative to a design for the specimen), tool coordinates, and the like. In this manner, the images can be retrieved from the context addressable storage subsystem based on where on the specimen an image was generated, where an image was generated relative to a design for the specimen, etc.

The computer subsystem(s) may also be configured for translating input coordinates for the image(s) to be retrieved to the coordinates to which the context corresponds. For example, if the images are to be retrieved based on design coordinates but the context associated with the images includes only specimen or tool coordinates, the computer subsystem(s) may translate the design coordinates to specimen or tool coordinates before retrieving data from the context addressable storage subsystem based on the coordinates. The computer subsystem(s) may translate coordinates from one such coordinate system to another in any suitable manner known in the art.

In one embodiment, the images to which the context is associated include image frames that serve as a unit of data for determining the information for the specimen. For example, the image frames may serve as a unit of data for inspection-related image processing. In particular, the term “image frames,” which is used interchangeably in the art with the term “frame images,” can be generally defined as a portion of image(s) that is generated for a specimen and collectively processed by a computer subsystem to determine information for the specimen. In one such example, image frames may be separately input to a defect detection method or algorithm as a unit of data to detect defects in an area of the specimen corresponding to the image frames. In this manner, different image frames may be separately input to the defect detection method or algorithm (possibly with other images or data associated therewith like reference image(s), a design image, etc.) to detect defects in each of the image frames. The image frames may have any suitable size known in the art, e.g., from 100 pixels by 100 pixels to 500 pixels by 8000 pixels. Obviously, therefore, the sizes of image frames vary from tool-to-tool as a function of the system configuration, e.g., field of view, numerical aperture, magnification, detector pixel size, resolution, image acquisition and processing speed capability, etc.

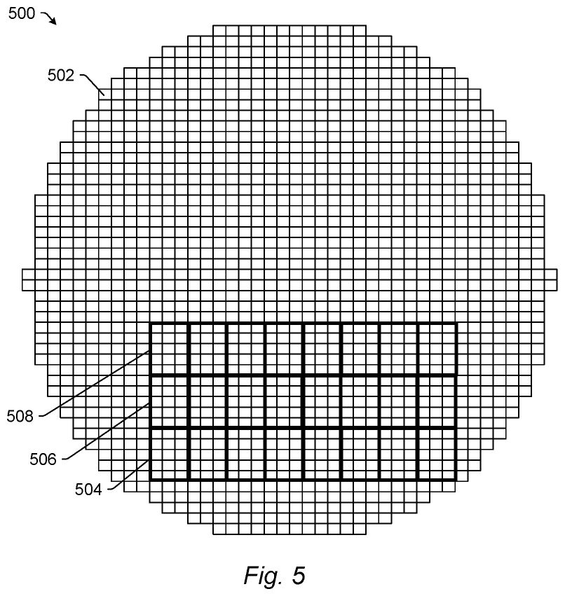

One non-limiting embodiment of image frames relative to a specimen is shown in FIG. 5. Specimen 500 is shown in FIG. 5 as a wafer although the description of FIG. 5 applies equally to other specimens described herein. Image frames of the specimen may be generated by the imaging subsystem in the areas outlined by the darker lined rectangles on the specimen. In other words, each of the darker lined rectangles shown in FIG. 5 represents a single image frame generated on the specimen. As shown in FIG. 5, the image frames may be generated in multiple swaths 504, 506, and 508 scanned on the specimen by the imaging subsystem. For example, the imaging subsystem may scan swath 504, then swath 506, and finally swath 508 in a serpentine-like pattern on the specimen. Although 3 swaths are shown in FIG. 5, the imaging subsystem may scan any number of swaths on the specimen. In addition, the image frames in the swaths and on the specimen are not meant to illustrate any actual characteristics of image frames that may be generated by the embodiments described herein and are meant to only promote understand of the invention.

The context described herein may, therefore, be associated with each of the 7 image frames in each of the 3 swaths. In other words, each image frame may have its own context (assigned by the imaging subsystem and/or the computer subsystem(s)) that is independent of the context of each other image frame. The context assigned to each image frame may include any one or more of the context types described herein.

Each of the image frames may include multiple patch images (or image patches), which may also be referred to by other terms in the art such as tiles. Patch images 502, corresponding to areas on the specimen shown by the smaller, lighter outlined boxes in FIG. 5, are shown covering the entire area of the specimen, but may cover less than the entire specimen area, e.g., only areas within the image frames and swaths. The image frames may be separated into tiles for various purposes in a process, or the embodiments described herein may be configured to separate the image frames into tiles for the purposes described herein. The tiles may or not be arranged in a regular array as shown in FIG. 5. For example, the tiles may correspond to care areas (CAs) on the specimen and may therefore be arranged in an irregular array on the specimen, as might be the case if not all areas on the specimen are to be inspected.

In any case, each of the tiles may also be associated its own context. In addition, each of the tiles within each of the image frames may have context associated therewith, which may be independent of the context assigned to the image frame it is located within and/or related to the context of the image frame in which it is located. For example, the context assigned to each tile may include context identifying the image frame in which it is located, its within image frame location information, etc. The context assigned to each tile may however also include other context information that is responsive to the tile and not (or to a lesser degree) the image frame in which it is located. Such context includes, but is not limited to, a characteristic of noise in the tile, context for a defect detected in the tile, CA information for the tile, or any other context described herein.

The context associated with each tile in an image frame may include some of the same context types as the context associated with the image frames, like at least spatial information. The context associated with the tiles may also include one or more different types of context than that associated with the image tiles. For example, the context associated with the tiles and the image frames may include different kinds of design information for the specimen. The context associated with the tiles may include design information for the specimen, and the context associated with the image frames may include noise characteristics of the image frames. Other context types described herein are also possible for the tiles. In this manner, the context associated with the tiles may be independent of the context associated with the image frames.

The context associated with the images that is stored by the computer subsystem(s) with the images in the context addressable storage subsystem may include one or more other types of context described herein in addition to context for at least the spatial information. For example, in another embodiment, the context associated with the images includes physical design data associated with the images. In this manner, one of the sources of the context may be physical design data associated with the frame in question. The physical design data associated with the images may include any of the design data described herein. The physical design data may also have any form or format known in the art.

In an additional embodiment, the context associated with the images includes information for CAs on the specimen. For example, one of the sources of context may be inspection CA data. “Care areas” as they are commonly referred to in the art are areas on a specimen that are of interest for inspection purposes. Sometimes, care areas (CAs) are used to differentiate between areas on the specimen that are inspected from areas on the specimen that are not inspected in an inspection process. In addition, CAs are sometimes used to differentiate between areas on the specimen that are to be inspected with one or more different parameters. For example, if a first area of a specimen is more critical than a second area on the specimen, the first area may be inspected with a higher sensitivity than the second area so that defects are detected in the first area with a higher sensitivity. Other parameters of an inspection process can be altered from CA to CA in a similar manner. The information for the CAs included in the context may include any suitable such data or information such as CA ID, CA location, CA size and shape, CA detection parameters, etc.

In a further embodiment, the context associated with the images includes information for one or more reticles used to print patterned features on the specimen in a lithography process. For example, another source of context may be information about the reticle(s) used to generate the wafer. The information for the reticles may include an ID of one or more of the reticles that was/were used to print patterned features on the specimen, design data for the one or more reticles, any qualification results associated with the reticle(s), information for any processes (e.g., repair processes) performed on the reticle(s), and the like. Such information may have any suitable form or format known in the art and may be acquired from any storage medium or tool known in the art.

Any of such context information may be useful for determining information for the reticle(s) from the images generated for the specimen. In one such example, the computer subsystem(s) may store context such as reticle coordinates associated with the images of the specimen. The computer subsystem(s) will then be able to retrieve any images of the specimen as described further herein based on their associated reticle coordinates for applications such as determining if defects were printed on the specimen at one or more specimen locations corresponding to any location on the reticle(s), determining one or more characteristics of patterned features printed on the specimen at one or more specimen locations corresponding to any location on the reticle(s), etc. The computer subsystem(s) may perform such determinations in the determining information step described further herein.

In some embodiments, the context associated with the images includes information for one or more processes performed on the specimen, and the one or more processes include an inspection process, a defect review process, a metrology process, or some combination thereof. For example, one of the sources of context may be production data, which may include prior inspection data, metrology data, virtual metrology data, and the like. Such production data may include any results of any such processes that were performed on the specimen prior to generation of the images.

In one such example, the images may be stored with context associated with any of the processes described above. If the images are being retrieved as described herein for the purpose of detecting defects on the specimen and/or determining information for defects detected on the specimen, the computer subsystem(s) may use the process-related context associated with the images to retrieve results generated by a process such as a metrology process performed on the specimen prior to the inspection process from the context addressable storage subsystem or a different computer-readable storage medium. In this manner, the computer subsystem(s) may retrieve metrology results from the context addressable storage subsystem or another storage medium for one or more locations on the specimen that are being inspected based on the context data associated with the images, which may include, for example, specimen information or ID, spatial information for where on the specimen the images were generated, information or ID of a metrology process performed on the specimen, information or ID of a metrology tool that performed the metrology process on the specimen, etc., rather than based on where in a storage medium/media the images or the metrology results are located and/or a configuration of that storage medium/media.

In another embodiment, the context associated with the images includes information for one or more processes performed on the specimen, and the one or more processes include a fabrication process performed on the specimen. A “fabrication process” as that term is used herein is generally defined as a process that is performed on specimens such as those described herein with the intent of altering one or more characteristics of the specimen (unlike yield related processes like inspection, metrology, and defect review, which are generally not intended to have any effect on the specimen or its characteristics). The one or more characteristics of the specimen that are altered in a fabrication process may include physical characteristics like size and shape of materials formed on the specimen, material composition characteristics like chemical composition of a film or features formed on the specimen, addition or removal of a material from the specimen, etc. One of the sources of the data may, therefore, be production data such as wafer processing history data including equipment sensor data and process control correction data. In this manner, the information for one or more processes performed on the specimen in the context associated with the images may be used to retrieve any data generated for the specimen during or after the fabrication process including, but not limited to, output of one or more fabrication tools that performed the fabrication process such as temperature, pressure, duration, composition of one or more gasses or materials input to the process or output by the fabrication process, reticle used to print patterned features on the specimen, images of the specimen generated by the one or more fabrication tools or imaging subsystems coupled thereto, measurements performed on the specimen during the fabrication process, output generated by the one or more fabrication tools or another system coupled thereto related to any process control correction that was done prior to, during, or after the fabrication process was performed on the specimen, and the like.

In an additional embodiment, the context associated with the images includes information for one or more conditions having a potential impact on the specimen prior to generating the images. For example, one of the sources of context may be any other data sources that can reasonably be expected to impact the state of a wafer including materials and ambient conditions. Such context may be acquired in any suitable manner, e.g., from a fab database or other storage medium, and may have any suitable form or format known in the art.

The computer subsystem(s) are also configured for retrieving one or more of the images based on the context associated with the images, as shown in step 304 of FIG. 3. For example, as shown in FIG. 4, upon receipt of context 412 from a recipe, i.e., context associated with an image that is to be used to determine information for a specimen in the process being performed with the recipe, the computer subsystem may send context 412 to context addressable storage subsystem 410 and/or otherwise retrieve images 414 from the context addressable storage subsystem that are associated with the context. The image retrieval may be performed as described further herein.

In one embodiment, retrieving the one or more of the images includes retrieving the one or more of the images in an order different from an order in which the images are generated for the specimen. For example, a virtual inspection system as described herein may provide random access to frame address data provided by the context addressable storage subsystem. In an additional embodiment, the imaging subsystem is configured for generating the images in swaths on the specimen, and retrieving the one or more of the images includes retrieving the one or more of the images in an order different from an order of the images in the swaths.

Having the capability to access and retrieve images in an order different than the order in which the images were generated and/or the order in which the specimen was scanned in swaths is one of the major improvements and advantages of the embodiments described herein over other currently available systems and methods. For example, some currently used methods and systems can access any stored image for a specimen but do so by replicating the “swathing” notion associated with the manner in which the images are generated and stored. In such systems and methods, the tool software regenerates the metadata required to find a specific image frame. While the images may still be stored in swaths in the embodiments described herein, the embodiments now persist the metadata (context) that can be used to fetch specific target image frames without playing back the images in swaths to regenerate the metadata associated with the images/swaths. Obviously, therefore, the embodiments described herein will have a much faster throughput, will cost much less, and will be much more practical for more applications than the currently available methods and systems for image storage and retrieval for the specimens and processes described herein.

The computer subsystem(s) are further configured for determining information for the specimen based on the retrieved one or more of the images and the context associated with the retrieved one or more of the images, as shown in step 306 of FIG. 3. For example, as shown in FIG. 4, computer subsystem(s) 406 may receive images 414 from context addressable storage medium 410 for context 412 and may determine information (e.g., specimen information 416) based on at least images 414, possibly with context 412. The computer subsystem(s) may be configured for determining one or more of the types of information described herein from the images, possibly in combination with the context.

In one embodiment, determining the information for the specimen includes altering one or more parameters of a method for determining other information for the specimen. In this manner, output 308 shown in FIG. 3 of the determining information step may include altered parameter(s) of a method for determining other information for the specimen.

In one such embodiment, altering the one or more parameters includes designing the method, selecting the method, training the method, optimizing the method, or some combination thereof. In another such embodiment, the other information includes information associated with defects on the specimen. For example, the intent of the context may be to serve as an input to one or more operations associated with the design, selection, training, optimization, inference, etc. of a defect inspection related algorithm pipeline or disposition of results thereof. In one such example, the computer subsystem(s) may be configured to use the context to inform algorithm parameters, e.g., dynamic thresholding per design or noise cluster. In this manner, the embodiments may optimize the algorithm pipeline. The retrieved images and the context associated therewith may therefore be used to setup a new inspection process, modify an existing process, tune an existing inspection process, optimize an existing inspection process, etc. The inspection process and defect detection algorithm and/or method that is setup or modified in this manner may include any defect detection algorithm and/or method known in the art.

The images and their context may be used to setup and/or modify a process or defect detection algorithm that is to be performed with the images. However, the images and their context may be used to setup and/or modify a process or algorithm that is different from the one the images were generated for and/or for a different specimen. For example, the images and their context that are stored and retrieved as described herein may be used by the computer subsystem(s) for determining one or more parameters of a different process that will be performed on the specimen. In one such example, the images may have been generated in an inspection process and then retrieved and used to setup or modify a defect review and/or metrology process that will be performed on the specimen. In a different example, the images and their context that are stored and retrieved as described herein for one specimen in an inspection process may be used by the computer subsystem(s) for determining one or more parameters of the inspection process that will be performed on a different specimen. The different specimen and the specimen for which the images were generated, stored, and retrieved as described herein may be of the same design or different designs.

In the same or a similar manner, the computer subsystem(s) may be configured for determining one or more parameters of a different kind of process based on the retrieved images and their context. For example, the computer subsystem(s) may determine one or more parameters of a fabrication process that will be performed on the specimen, which may include any of the fabrication processes described herein, and/or one or more parameters of one or more of the fabrication processes that were performed on the specimen and will be performed on one or more other specimens (of the same or different type). These steps may be performed as described further herein.

In an additional embodiment, determining the information for the specimen includes detecting defects on the specimen. For example, output 310 shown in FIG. 3 of the determining information step may include detected defects on the specimen. Detecting defects on the specimen may be performed in any suitable manner known in the art. The images and their context may be input to any suitable defect detection algorithm and/or method known in the art. In perhaps the simplest manner, the defect detection algorithm and/or method may subtract a reference image from the retrieved images thereby generating difference images. A defect detection threshold may then be applied to the difference images and any pixels having a value above the threshold may be identified as a defect or potential defect. The defect detection algorithm and/or method may generate any suitable output for the defects or potential defects. In addition, the computer subsystem(s) described herein may determine information for the defects detected on the specimen as described herein. The results of the defect detection may be generated and used as described further herein.

In another embodiment, determining the information for the specimen includes determining information for defects detected on the specimen. For example, output 312 shown in FIG. 3 may include information for defects detected on the specimen. In one such example, after defects have been detected with the images and possibly their context as described further herein, the computer subsystem(s) may determine information for any detected defects from the images, the context, and any other information described herein. Determining information for the detected defects may include, but is not limited to, determining attributes for the defects, which may include simply the context associated with the location in the images at which the defects were detected, but also attributes for the defects determined from the images that is different from the context. For example, attributes like size, shape, proximity to patterned features on the specimen, proximity to other defects detected on the specimen, and the like may be determined from the images and their associated context based on the locations of the detected defects in the images. The computer subsystem(s) may also perform other functions for the defects like nuisance filtering, binning, and the like.

In some embodiments, the computer subsystem(s) are configured for retrieving additional information for the specimen from an additional computer-readable storage medium based on the context associated with the images, as shown in step 314 of FIG. 3. For example, the context addressable storage subsystem may be configured so that the retrievable data from the virtual inspection system includes sufficient information to formulate queries of another data storage system (including context addressable and non-context addressable storage subsystems) for the purpose of acquiring additional helpful context information. The computer subsystem(s) may formulate a query by generating a fully formed query based on information available from the virtual inspection system (with its associated metadata). The computer subsystem(s) may however simply make a query based on the context associated with images being requested or any other requested information.

In one such embodiment, computer subsystem(s) 406 shown in FIG. 4 may be configured for sending context from recipe 412 or otherwise using context 412 for retrieving additional information 420 from additional computer-readable storage medium 418. Additional information retrieved from the additional computer-readable storage medium may then be used with the images retrieved from the context addressable storage medium to determine information for the specimen. In one such example, the additional information may include a design for the specimen, which may be used with the images retrieved from the context addressable storage medium to determine information for the specimen. In another such example, the additional information may be used with the information determined from the images to determine other information for the specimen. For example, if the information determined from the images is defects detected on the specimen and if the additional information is design information for the specimen, the computer subsystem(s) may use the additional information to filter the defects, to determine attributes for the defects, to classify the defects, etc. The additional computer-readable storage medium may be a context addressable storage medium that has a configuration described herein or any other suitable context addressable storage medium known in the art. The additional computer-readable storage medium may also be any other computer-readable storage medium known in the art including non-context addressable computer-readable storage media.

The embodiments described herein provide improvements and advantages over currently used methods and systems in addition to those already described. For example, the embodiments described herein provide mechanisms to explicitly incorporate data that is not normally part of the inspection process into the interpretation of image data from an inspector and other tools described herein. Some currently used systems have a defect source analysis (DSA) feature that allows the ingress of inspection results from previous inspection(s) so that redetection of preexisting defects from a prior process layer can be labeled. However, this is a much more limited use of context during inspection.

Other context based inspection methods and systems are also available currently. While such context based inspection systems and methods have had (and will likely continue to have) important applications in the art, the embodiments described herein are different from such systems and methods because they provide the ability to store all of the images of a specimen generated during a process with their associated context in a manner (in the context addressable storage subsystem) so that any image generated during the process can be retrieved from storage based on the context associated with the image being retrieved without regeneration of the context (e.g., via playing back images in a stored swath of images). In other words, the embodiments described herein do not store just inspection results for a specimen with the associated context, but can store all of the generated images with their associated context and with context that is not just generated during the process and/or with different types of context.

The embodiments described herein also do not just find prior inspection results for a location on a specimen being inspected, but can store and retrieve any image generated of a specimen during a process based on any context associated therewith. The retrieved images can therefore be processed and used in different ways during the process (e.g., reexamined, post-processed in a different manner, stacked by design coordinates, etc.) based on any context that is available to the embodiments and stored with the images. In one such example, the images can be retrieved and essentially reinspected for any specimen location found after inspection to be interesting, problematic, suspected of defects that were not detected, etc.

Storing the images of the specimen as described herein makes the images much more useful not just with other existing data like process information, reticle information, prior inspection results, etc. but also more useful for determining information for the specimen, the process(es) performed on it, etc. with additional information generated for the specimen at a later time. For example, after the images of the specimen have been stored as described herein, if additional fabrication and inspection processes are performed on the specimen, the images may be retrieved based on their context and used or reused to determine additional information for the specimen, the additional processes performed thereon, etc. In one such example, the images generated for the specimen at the same location and after different fabrication processes may be overlaid with one another or displayed in another useful manner that may provide insight to a user as to how one layer on the specimen affects another, later-formed layer on the specimen, to visualize overlay of patterned features on different layers of the specimen, and the like.

The scale and complexity of the specimens and processes described herein have heretofore made such applications impractical and even impossible except for perhaps strictly (e.g., one or two) predesignated locations on a specimen. The embodiments described herein, however, make such applications extremely practical, efficient, and cost effective even for locations that were perhaps not of interest at the time of image generation but that become interesting, concerning, problematic, etc. at a later time. The capabilities of the embodiments described herein will therefore promote discovery and understanding of the specimens and processes described herein in ways that were previously unavailable or impossible.

The computer subsystem(s) may also be configured for generating results that include the determined information, which may include any of the results or information described herein. The results of determining the information may be generated by the computer subsystem(s) in any suitable manner. All of the embodiments described herein may be configured for storing results of one or more steps of the embodiments in a computer-readable storage medium. The results may include any of the results described herein and may be stored in any manner known in the art. The results that include the determined information may have any suitable form or format such as a standard file type. The storage medium may include any storage medium described herein or any other suitable storage medium known in the art.

After the results have been stored, the results can be accessed in the storage medium and used by any of the method or system embodiments described herein, formatted for display to a user, used by another software module, method, or system, etc. to perform one or more functions for the specimen or another specimen of the same type. In addition, the results may include any information for the specimen determined as described herein.

That information may be used by the computer subsystem(s) or another system or method for performing additional functions for the specimen. Such functions include, but are not limited to, altering a process such as a fabrication process or step that was or will be performed on the specimen in a feedback or feedforward manner, etc. For example, the computer subsystem(s) may be configured to determine one or more changes to a process that was performed on the specimen and/or a process that will be performed on the specimen based on the detected defects. The changes to the process may include any suitable changes to one or more parameters of the process. The computer subsystem(s) preferably determine those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem(s) may determine such changes in any suitable manner known in the art.

Those changes can then be sent to a semiconductor fabrication system (not shown) or a storage medium (not shown) accessible to both the computer subsystem(s) and the semiconductor fabrication system. The semiconductor fabrication system may or may not be part of the system embodiments described herein. For example, the imaging hardware and/or the computer subsystem(s) described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments of each of the systems described above may be combined together into one single embodiment.

Another embodiment relates to a computer-implemented method for generating information for a specimen. The method includes generating images (402 shown in FIG. 4) of a specimen with an imaging subsystem (e.g., 400), as shown in step 300 of FIG. 3. The method also includes storing the images in a context addressable storage subsystem (410 shown in FIG. 4) with context (404) associated with the images (i.e., images with context 408), as shown in step 302 of FIG. 3. The context includes at least spatial information for the images relative to one or more coordinate systems. In addition, the method includes retrieving one or more of the images (414 as shown in FIG. 4) based on the context associated with the images, as shown in step 304 of FIG. 3. The method further includes determining information (416 shown in FIG. 4) for the specimen (14 shown in FIG. 1) based on the retrieved one or more of the images and the context associated with the retrieved one or more of the images, as shown in step 306 of FIG. 3. The storing, retrieving, and determining steps are performed by one or more computer subsystems (406 shown in FIG. 4).

Each of the steps of the method may be performed as described further herein. The method may also include any other step(s) that can be performed by the imaging subsystem and/or computer subsystem(s) described herein, which may be configured according to any of the embodiments described herein. In addition, the method described above may be performed by any of the system embodiments described herein.

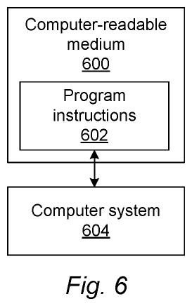

An additional embodiment relates to a non-transitory computer-readable medium storing program instructions executable on one or more computer subsystems for performing a computer-implemented method for generating information for a specimen. One such embodiment is shown in FIG. 6. In particular, as shown in FIG. 6, non-transitory computer-readable medium 600 includes program instructions 602 executable on computer system 604. The computer-implemented method may include any step(s) of any method(s) described herein.

Program instructions 602 implementing methods such as those described herein may be stored on computer-readable medium 600. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 604 may be configured according to any of the embodiments described herein.

Further modifications and alternative embodiments of various aspects of the invention will be apparent to those skilled in the art in view of this description. For example, methods and systems for generating information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for generating information for a specimen, comprising:
an imaging subsystem configured for generating images of a specimen;
a context addressable storage subsystem; and
one or more computer subsystems configured for:
storing the images in the context addressable storage subsystem with context associated with the images, wherein the context comprises at least spatial information for the images relative to one or more coordinate systems;
retrieving one or more of the images based on the context associated with the images; and
determining information for the specimen based on the retrieved one or more of the images and the context associated with the retrieved one or more of the images.

2. The system of claim 1, wherein the images to which the context is associated comprise image frames that serve as a unit of data for determining the information for the specimen.

3. The system of claim 1, wherein determining the information for the specimen comprises altering one or more parameters of a method for determining other information for the specimen.

4. The system of claim 3, wherein said altering comprises designing the method, selecting the method, training the method, optimizing the method, or some combination thereof.

5. The system of claim 3, wherein the other information comprises information associated with defects on the specimen.

6. The system of claim 1, wherein determining the information for the specimen comprises detecting defects on the specimen.

7. The system of claim 1, wherein determining the information for the specimen comprises determining information for defects detected on the specimen.

8. The system of claim 1, wherein the one or more computer subsystems are further configured for retrieving additional information for the specimen from an additional computer-readable storage medium based on the context associated with the images.

9. The system of claim 1, wherein the imaging subsystem is further configured for generating the images by directing energy to a physical version of the specimen and detecting energy from the physical version of the specimen.

10. The system of claim 1, wherein the imaging subsystem is further configured as a virtual imaging subsystem configured for generating the images from a computer-readable storage medium in which the images have been stored by an additional imaging subsystem configured for generating the images by directing energy to a physical version of the specimen and detecting energy from the physical version of the specimen.

11. The system of claim 1, wherein the context associated with the images further comprises physical design data associated with the images.

12. The system of claim 1, wherein the context associated with the images further comprises information for care areas on the specimen.

13. The system of claim 1, wherein the context associated with the images further comprises information for one or more reticles used to print patterned features on the specimen in a lithography process.

14. The system of claim 1, wherein the context associated with the images further comprises information for one or more processes performed on the specimen, and wherein the one or more processes comprise an inspection process, a defect review process, a metrology process, or some combination thereof.

15. The system of claim 1, wherein the context associated with the images further comprises information for one or more processes performed on the specimen, and wherein the one or more processes comprise a fabrication process performed on the specimen.

16. The system of claim 1, wherein the context associated with the images further comprises information for one or more conditions having a potential impact on the specimen prior to generating the images.

17. The system of claim 1, wherein retrieving the one or more of the images comprises retrieving the one or more of the images in an order different from an order in which the images are generated for the specimen.

18. The system of claim 1, wherein the imaging subsystem is further configured for generating the images in swaths on the specimen, and wherein retrieving the one or more of the images comprises retrieving the one or more of the images in an order different from an order of the images in the swaths.

19. A non-transitory computer-readable medium, storing program instructions executable on one or more computer subsystems for performing a computer-implemented method for generating information for a specimen, wherein the computer-implemented method comprises:
generating images of a specimen with an imaging subsystem;
storing the images in a context addressable storage subsystem with context associated with the images, wherein the context comprises at least spatial information for the images relative to one or more coordinate systems;
retrieving one or more of the images based on the context associated with the images; and
determining information for the specimen based on the retrieved one or more of the images and the context associated with the retrieved one or more of the images, wherein said storing, retrieving, and determining are performed by the one or more computer subsystems.

20. A computer-implemented method for generating information for a specimen, comprising:
generating images of a specimen with an imaging subsystem;
storing the images in a context addressable storage subsystem with context associated with the images, wherein the context comprises at least spatial information for the images relative to one or more coordinate systems;
retrieving one or more of the images based on the context associated with the images; and
determining information for the specimen based on the retrieved one or more of the images and the context associated with the retrieved one or more of the images, wherein said storing, retrieving, and determining are performed by one or more computer subsystems.
